(19) United States
(12) Patent Application Publication
(10) Pub. No.: US 2020/0152376 A1
(43) Pub. Date: May 14, 2020

(54) COIL UNIT

(71) Applicant: Toyota Jidosha Kabushiki Kaisha, Toyota-shi (JP)

(72) Inventor: Syunsuke Nakane, Toyota-shI (JP)

(21) Appl. No.: 16/675,844

(22) Filed: Nov. 6, 2019

(30) Foreign Application Priority Data
Nov. 12, 2018 (JP) 2018-211920

(51) Int. Cl. H01F 27/30; H01F 27/32; H01F 27/29; H01F 27/04; H01F 38/14; B60L 53/12; H02J 50/12

(52) U.S. Cl. CPC H01F 27/306; H01F 27/324; H01F 27/29; H02J 50/12; H01F 38/14; B60L 53/12; H01F 27/04

(57) ABSTRACT

A coil unit includes a coil formed by winding a coil wire. The coil wire includes a conductive first terminal and second terminal. The first terminal includes a connection portion connected to an external terminal on a device, and a protruding portion protruding from the connection portion and connected to a conductor. The protruding portion increases its distance from the second terminal with distance from the connection portion.

### CROSS REFERENCE TO RELATED APPLICATIONS

This nonprovisional application claims priority to Japanese Patent Application No. 2018-211920 filed on Nov. 12, 2018 with the Japan Patent Office, the entire contents of which are hereby incorporated by reference.

### BACKGROUND

### Field

The present disclosure relates to a coil unit.

### Description of the Background Art

Various types of wireless charging systems have been conventionally proposed in which power is wirelessly transmitted from a power-transmission-side coil unit to a coil unit.

A coil unit described in Japanese Patent Laying-Open No. 2018-082088 includes a spiral power reception coil, a capacitor, and a rectifier.

The coil surrounds the vertically extending winding axis and has a hole vertically extending therethrough at its central part. The capacitor is disposed above the hole.

### SUMMARY

In a coil unit for wireless charging, both ends of a coil are connected to devices, such as a capacitor and a rectifier. If the ends of the coil are disposed at the outer periphery of the coil with the devices connected to the ends, the coil size may be increased. Accordingly, the ends of the coil may be disposed in the hole of the coil with the devices connected to the ends.

For example, a capacitor has two pin terminals. The ends of a coil need to have terminals for connection to these two pin terminals.

A coil is formed by winding a coil wire which includes a conductor and an insulation coating covering the conductor. For forming a terminal, an insulation coating is removed from an end of the coil wire, for example. Then, the exposed conductor is crimped into a terminal. The terminal includes a ring-shaped connection portion, and a protruding portion protruding from the connection portion. The ring-shaped connection portion is fitted on a pin terminal provided at the capacitor. The protruding portion connects between the connection portion and the conductor of the coil wire. Both terminals are connected to the capacitor disposed in the hole of the power reception coil.

In the power reception coil unit configured as described above, when the power reception coil receives power, a great potential difference arises between the terminals. Accordingly, an insulation distance needs to be kept between the terminals of the coil.

The present disclosure has been made in view of such a problem. An object of the present disclosure is to provide a coil unit for use in a wireless charging system and that ensures the insulating properties between the terminals provided at both ends of a coil.

A coil unit according to the present disclosure is a coil unit including: a coil formed by winding a coil wire around a winding axis, the coil having a hole at a central part thereof; and a device connected to the coil. The coil wire includes a conductor, and an insulation coating covering the conductor. The coil includes a conductive first terminal formed at a first end of the coil and exposed from the insulation coating, and a conductive second terminal formed at a second end of the coil and exposed from the insulation coating. A portion of the coil that is located at the first end, and a portion of the coil that is located at the second end are led into the hole. The first terminal includes a connection portion connected to an external terminal on the device, and a protruding portion protruding from the connection portion and connected to the conductor. The protruding portion increases its distance from the second terminal with distance from the connection portion.

In the coil unit, the distance between the protruding portion of the first terminal and the second terminal is ensured. Accordingly, the insulating properties can be easily ensured between the protruding portion of the first terminal and the second terminal at the time of power reception.

The coil unit further includes a metal container containing an electric device therein. The container is located adjacent to the coil. The number of winding turns in a first portion is larger than the number of winding turns in a second portion, the first portion being a portion of the coil that is located on a side of the container, the second portion being a portion of the coil that is located on a side opposite to the first portion with respect to the winding axis.

According to the coil unit, when the two coil units for power transmission and reception are displaced relative to each other, the coefficient of coupling does not so greatly vary depending on the displacement direction.

The coil unit further includes a metal member adjacent to the coil unit outside the coil unit. The number of winding turns in a third portion is larger than the number of winding turns in a fourth portion, the third portion being a portion of the coil that is located on a side of the metal member, the fourth portion being a portion of the coil that is located on a side opposite to the third portion with respect to the winding axis.

According to the coil unit, when the two coil units for power transmission and reception are displaced relative to each other, the coefficient of coupling does not so greatly vary depending on the displacement direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram showing a wireless charging system 1.

FIG. 2 is a circuit diagram schematically showing a circuit configuration of a power-transmission-side coil unit 3 and a power-reception-side coil unit 4.

FIG. 3 is an exploded perspective view showing a configuration of coil unit 4 and components around coil unit 4.

FIG. 4 is a cross-sectional view showing a part of coil unit 4.

FIG. 5 is a plan view with a power reception coil 15, a ferrite 25, a metal plate 28, and resonant capacitors 16a, 16b viewed from below.

FIG. 6 is a perspective view showing a configuration of terminals 60, 61 and components around terminals 60, 61.

FIG. 7 is a plan view showing terminals 60, 61 and pin terminals 90, 91.

FIG. 8 is a plan view showing power reception coil 15 and metal plate 28.

FIG. 9 is a plan view schematically showing a coil unit 4A.

FIG. 10 is a plan view showing a configuration of terminals 60A, 61A and components around terminals 60A, 61A.

FIG. 11 is a plan view schematically showing a state in which coil unit 3 is displaced to the left relative to coil unit 4.

FIG. 12 is a plan view schematically showing a state in which coil unit 3 is displaced to the right relative to coil unit 4.

FIG. 13 is a plan view showing a state in which power transmission coil 10 is displaced to the left relative to power reception coil 15A.

FIG. 14 is a plan view showing a state in which power transmission coil 10 is displaced to the right relative to power reception coil 15A.

FIG. 15 is a graph showing the difference in coefficient of coupling between when power transmission coil 10 is displaced to the left relative to power reception coil 15, 15A, and when power transmission coil 10 is displaced to the right relative to power reception coil 15, 15A.

FIG. 16 is a plan view schematically showing a coil unit 4B in a variation.

FIG. 17 is a plan view showing a state in which power transmission coil 10 is displaced to the right relative to a power reception coil 15B.

### DETAILED DESCRIPTION

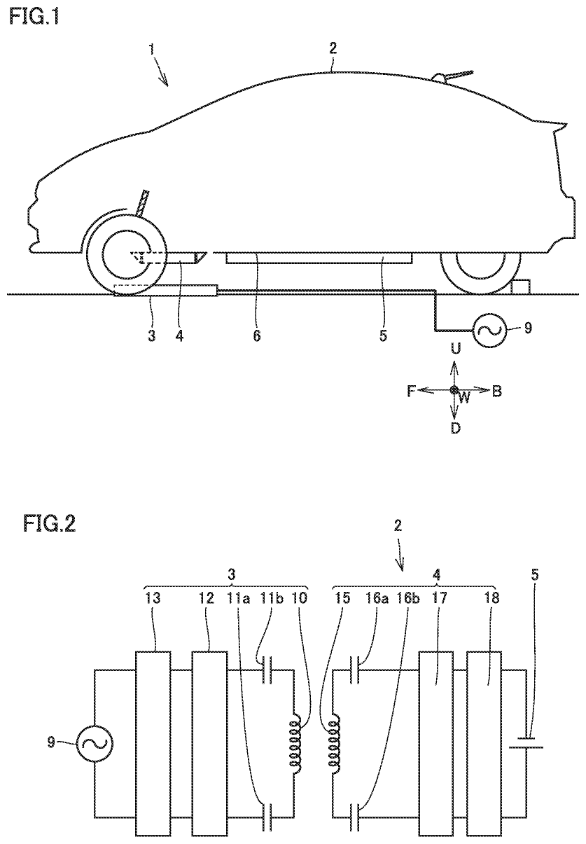

With reference to FIG. 1 to FIG. 17, a coil unit in the present embodiment is described. Among the components shown in FIG. 1 to FIG. 17, identical or substantially identical components are denoted by identical reference signs, and redundant description is omitted. The components recited in the claims may be written in parentheses along with the corresponding components recited in the embodiment.

FIG. 1 is a schematic diagram showing a wireless charging system 1. Wireless charging system 1 includes a power-reception-side coil unit 4 provided on a vehicle 2, and a power-transmission-side coil unit 3.

Coil unit 3 is connected to a power supply 9 and receives power supplied from power supply 9.

Vehicle 2 includes a floor panel 6, coil unit 4, and a battery 5. Floor panel 6 is a metal plate that forms the bottom of vehicle 2. Coil unit 4 and battery 5 are provided on the lower face of floor panel 6. Coil unit 4 is provided on the front side relative to battery 5.

FIG. 2 is a circuit diagram schematically showing a circuit configuration of power-transmission-side coil unit 3 and power-reception-side coil unit 4. Coil unit 3 includes a power transmission coil 10, resonant capacitors 11a, 11b, a filter 12, and an inverter 13.

Power transmission coil 10 and resonant capacitors 11a, 11b form a resonant circuit having a Q factor of 100 or more.

Coil unit 4 includes a power reception coil 15, resonant capacitors 16a, 16b, a filter 17, and a rectifier 18.

Power reception coil 15 and resonant capacitors 16a, 16b form a resonant circuit having a Q factor of 100 or more.

For wireless power transmission from coil unit 3 to coil unit 4, AC power is supplied from power supply 9 to inverter 13.

Inverter 13 adjusts the frequency of the supplied AC current, and supplies it to filter 12. Filter 12 removes noise from the AC current supplied from inverter 13, and supplies it to, for example, power transmission coil 10. When the AC current is supplied to power transmission coil 10, an electromagnetic field is formed around power transmission coil 10.

Power reception coil 15 receives power from the electromagnetic field. This causes a current to flow in power reception coil 15 and forms an electromagnetic field around power reception coil 15. The AC current received by power reception coil 15 is supplied to filter 17. Filter 17 removes noise from the AC current supplied from power reception coil 15, and supplies it to rectifier 18. Rectifier 18 converts the supplied AC power into DC power, and supplies the DC power to battery 5.

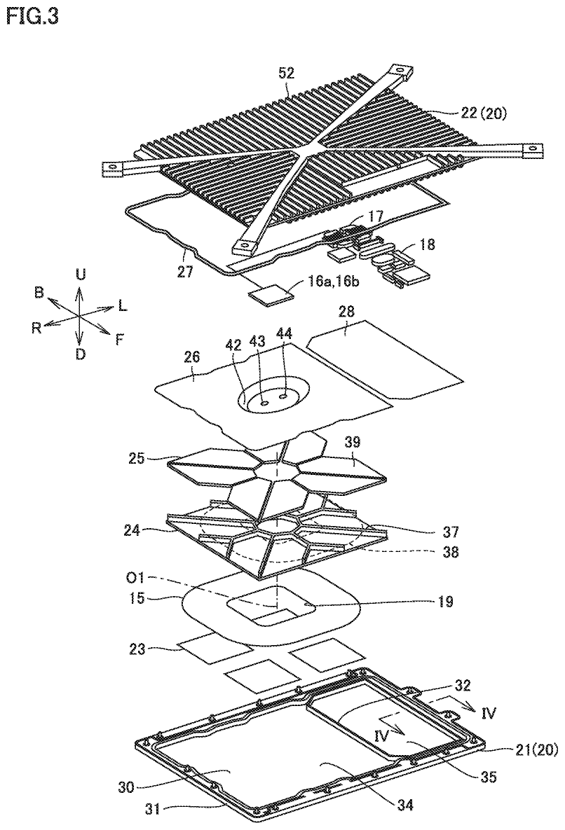

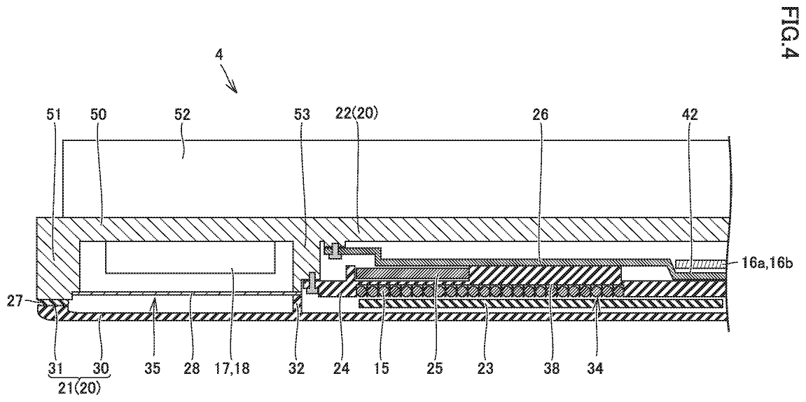

FIG. 3 is an exploded perspective view showing a configuration of coil unit 4 and components around coil unit 4. FIG. 4 is a cross-sectional view showing a part of coil unit 4.

Coil unit 4 includes a case 20, a protective sheet 23, power reception coil 15, a bobbin 24, a ferrite 25, metal plates 26, 28, a sealing member 27, resonant capacitors 16a, 16b, filter 17, and rectifier 18.

Case 20 includes a resin cover 21 and a body 22.

As shown in FIG. 4, body 22 includes a top plate 50, a peripheral wall 51, a cooling plate 52, and a partition wall 53. Top plate 50 is disposed on the upper side of body 22. Peripheral wall 51 extends downward from the outer peripheral edge of top plate 50. Peripheral wall 51 has a ring shape along the outer peripheral edge of top plate 50. A plurality of cooling plates 52 are formed on the upper face of top plate 50.

In FIG. 3, resin cover 21 is disposed on the lower side of case 20. Resin cover 21 includes a bottom plate 30, a peripheral wall 31, and a frame wall 32. Bottom plate 30, peripheral wall 31, and frame wall 32 are composed of, for example, resin. Peripheral wall 31 rises up from the outer peripheral edge of bottom plate 30.

Frame wall 32 partitions the space in case 20 into a coil space 34 and a device space 35, in cooperation with partition wall 53 shown in FIG. 4.

Protective sheet 23, power reception coil 15, bobbin 24, ferrite 25, metal plate 26, and resonant capacitors 16a, 16b are disposed in coil space 34. Filter 17 and rectifier 18 are disposed in device space 35.

Protective sheet 23 is disposed on the upper face of bottom plate 30 in coil space 34. Power reception coil 15 is disposed on protective sheet 23. Power reception coil 15 surrounds the vertically extending winding axis O1. Power reception coil 15 has a hole 19 at its central part.

Bobbin 24 is disposed on the upper side of power reception coil 15. Bobbin 24 has a coil groove 38 in its lower face for power reception coil 15 to be fitted therein. Coil groove 38 surrounds winding axis O1 in the same form as power reception coil 15. Bobbin 24 has a support wall 37 on its upper face.

Ferrite 25 is disposed on the upper face of bobbin 24. Ferrite 25 includes a plurality of division ferrite plates 39 surrounding winding axis O1. Division ferrite plates 39 are disposed on the upper face of bobbin 24 so that the peripheries of division ferrite plates 39 are supported by support wall 37.

Metal plate 26 is disposed on the upper side of ferrite 25 in coil space 34. Metal plate 26 is composed of a metallic material, such as aluminum. Metal plate 26 is in the form of a plate and has a recess 42 at its central part. Recess 42 protrudes downward. Recess 42 has through-holes 43, 44 in its bottom.

Resonant capacitors 16a, 16b are disposed in recess 42, on the upper side of metal plate 26.

Metal plate 28 is fixed to the lower end face of partition wall 53. Filter 17 and rectifier 18 are disposed on the upper side of metal plate 28. Rectifier 18 and filter 17 are disposed in the space defined by partition wall 53, top plate 50, metal plate 28, and peripheral wall 51. That is, in FIG. 4, metal plate 28, peripheral wall 51, partition wall 53, and top plate 50 constitute a container that contains devices, such as rectifier 18 and filter 17.

Sealing member 27 is disposed between peripheral wall 31 of resin cover 21 and peripheral wall 51 of body 22. Sealing member 27 can block a foreign substance, such as water, from entering case 20.

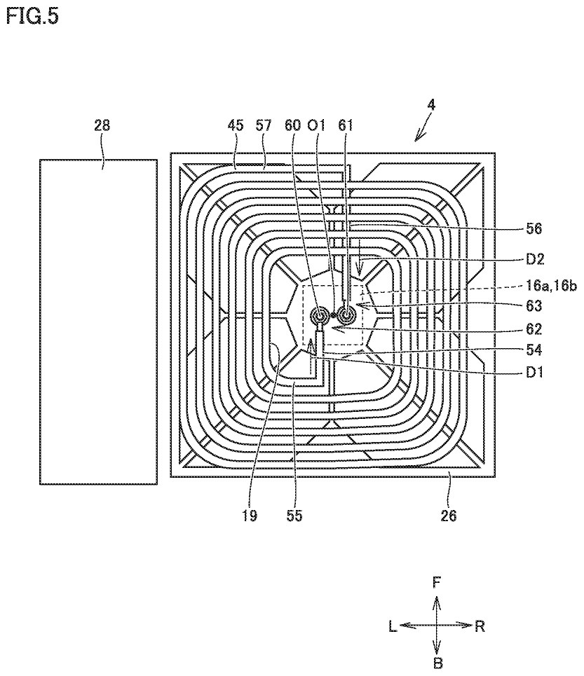

FIG. 5 is a plan view with power reception coil 15, ferrite 25, metal plate 28, and resonant capacitors 16a, 16b viewed from below.

Power reception coil 15 is formed by winding a coil wire 45 to surround winding axis O1. Power reception coil 15 is a spiral coil.

Power reception coil 15 includes a terminal 60 formed at an end 62 of power reception coil 15, and a terminal 61 formed at an end 63 of power reception coil 15.

Terminals 60, 61 are located in hole 19. Coil wire 45 includes an interconnection 54 and a curved portion 55. Interconnection 54 has one end connected to terminal 60, and extends from the one end, terminal 60, toward the inner periphery of hole 19. Curved portion 55 is connected to the other end of interconnection 54, and extends along the inner periphery of hole 19.

At end 63, power reception coil 15 includes an interconnection 56 and a curved portion 57. Interconnection 56 has one end connected to terminal 61, and extends toward the outer periphery of power reception coil 15. Interconnection 56 has the other end located at the outer periphery of power reception coil 15, with curved portion 57 being connected to the other end of interconnection 56. Curved portion 57 extends along the outer periphery of power reception coil 15.

Interconnection 54 is led from the inner periphery edge of power reception coil 15 in an extending direction D1 toward hole 19. Interconnection 56 is led from the outer peripheral edge of power reception coil 15 in an extending direction D2 toward hole 19. Extending direction D1 and extending direction D2 are opposite directions.

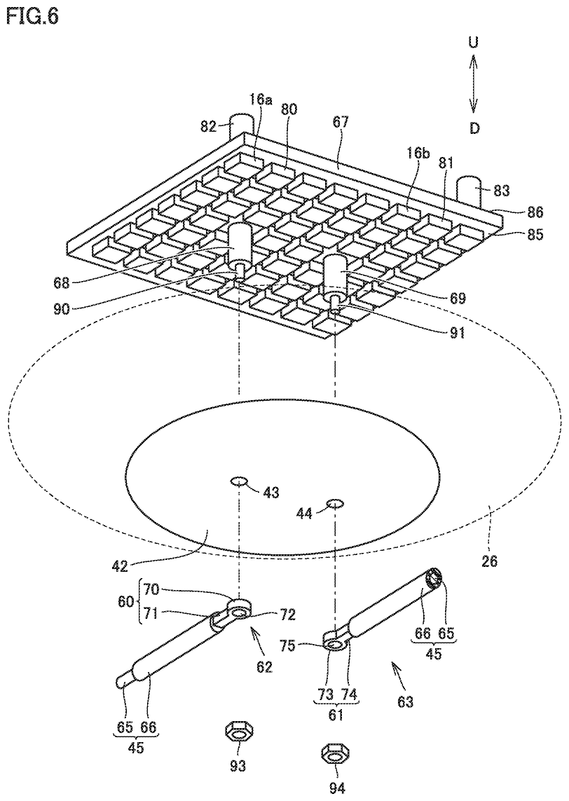

FIG. 6 is a perspective view showing a configuration of terminals 60, 61 and components around terminals 60, 61. Coil wire 45 includes a conductor 65 and an insulation coating 66. Conductor 65 is composed of a metallic material, such as copper. Insulation coating 66 covers the surface of conductor 65 and is composed of an insulating material, such as resin.

Terminal 60 and terminal 61 are exposed from insulation coating 66. Terminal 60 includes a connection portion 70 and a protruding portion 71. Connection portion 70 has a ring shape with an insertion hole 72 formed therein. Protruding portion 71 connects between connection portion 70 and conductor 65 at end 62.

Terminal 61 is formed similarly to terminal 60. Terminal 61 includes a connection portion 73 and a protruding portion 74. Connection portion 73 has a ring shape with an insertion hole 75 formed therein. Protruding portion 74 connects between connection portion 73 and conductor 65 at end 63.

Resonant capacitors 16a, 16b are provided on the lower face 85 of a substrate 67. Resonant capacitor 16a includes a plurality of capacitor elements 80, an external terminal 68, and an external terminal 82. Resonant capacitor 16b includes a plurality of capacitor elements 81, an external terminal 69, and an external terminal 83. Capacitor elements 80, 81 and external terminals 68, 69 are formed on lower face 85 of substrate 67; whereas external terminals 82, 83 are formed on the upper face 86 of substrate 67.

External terminal 68 includes a pin terminal 90 to be inserted in insertion hole 72 of connection portion 70. External terminal 69 includes a pin terminal 91 to be inserted in insertion hole 75 of connection portion 73.

External terminal 68 is inserted in through-hole 43 formed in metal plate 26, and pin terminal 90 protrudes from through-hole 43. Connection portion 70 is fitted on pin terminal 90, and a nut 93 is fitted on a part of pin terminal 90 that protrudes from connection portion 70. Thus, connection portion 70 is fixed to external terminal 68.

External terminal 69 is inserted in through-hole 44 formed in metal plate 26, and pin terminal 91 protrudes from through-hole 44. Insertion hole 75 is fitted around pin terminal 91, and a nut 94 is fitted on a part of pin terminal 91 that protrudes from protruding portion 71. Thus, connection portion 73 is fixed to external terminal 69.

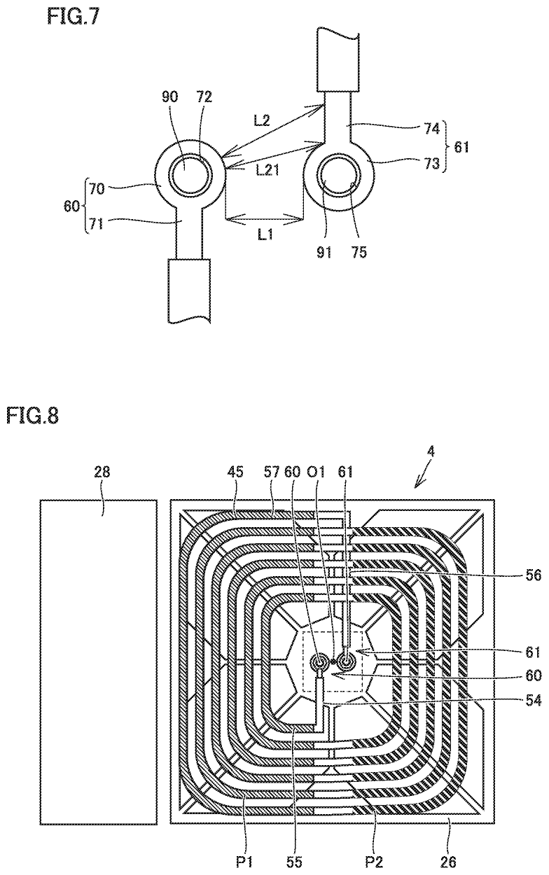

FIG. 7 is a plan view showing terminals 60, 61 and pin terminals 90, 91. The distance between pin terminal 90 and pin terminal 91 is set such that the insulating properties between pin terminal 90 and pin terminal 91 can be ensured even when a voltage of about several kV is applied to pin terminal 90 and pin terminal 91.

Connection portions 70, 73 each have a circumferential face. Distance L1 between connection portion 70 and connection portion 73 (the shortest distance between connection portion 70 and connection portion 73) does not so greatly differ from the distance between pin terminal 90 and pin terminal 91. That is, the distance between connection portion 70 and connection portion 73 is kept enough to ensure the insulating properties between them.

In FIG. 7, distance L2 is the distance between protruding portion 74 and terminal 60. Protruding portion 74 increases its distance L2 from terminal 60 with distance from connection portion 73. In FIG. 7, distance L21 is the shortest distance between protruding portion 74 and terminal 60. As is clear from FIG. 7, distance L21 is longer than distance L1.

Thus, in coil unit 4 in the present embodiment, the insulating properties between terminal 60 and terminal 61 are ensured even when a potential difference of several kV arises between terminal 60 and terminal 61.

FIG. 8 is a plan view showing power reception coil 15 and metal plate 28. In FIG. 8, “portion P1” is a portion of power reception coil 15 that is located on the metal plate 28 side; and “portion P2” is a portion that is located opposite to portion P1 with respect to winding axis O1. In FIG. 8, portion P1 is indicated by thin hatching, and portion P2 is indicated by thick hatching.

In the example shown in FIG. 8, the number of winding turns of coil wire 45 is larger in portion P1 than in portion P2.

Next, by comparing coil unit 4 in the present embodiment with a coil unit 4A in a comparative example, the advantage of coil unit 4 is described.

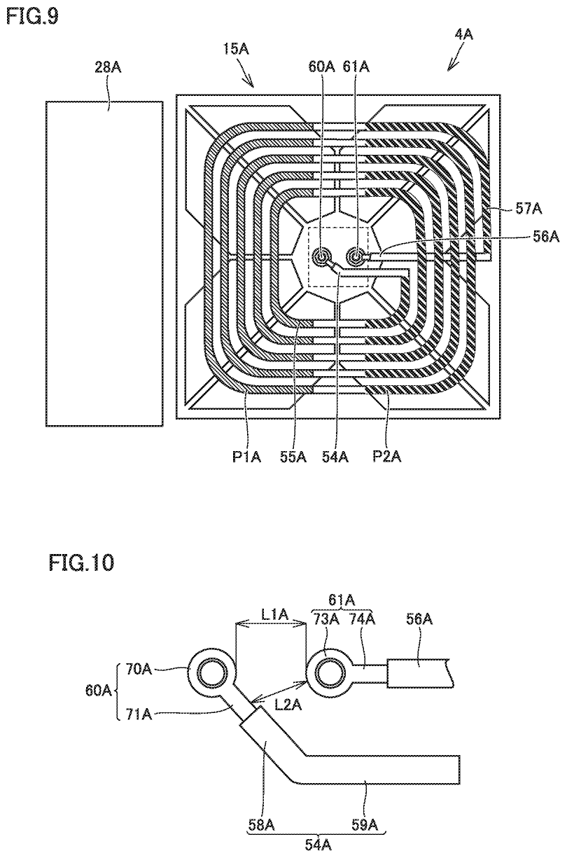

FIG. 9 is a plan view schematically showing coil unit 4A. Coil unit 4A includes a power reception coil 15A. Coil unit 4A is substantially the same in configuration as coil unit 4 except for power reception coil 15A.

As shown in FIG. 9, in power reception coil 15A, the number of winding turns of coil wire 45 is uniform over substantially the whole circumference.

Power reception coil 15A includes terminals 60A, 61A, an interconnection 54A, a curved portion 55A, an interconnection 56A, and a curved portion 57A.

Terminal 60A is provided at one end of power reception coil 15A, and terminal 61A is provided at the other end of power reception coil 15A.

Interconnection 54A has one end connected to terminal 60A, and extends from terminal 60A toward the inner periphery of hole 19A.

Interconnection 56A has one end connected to terminal 61A, and reaches the outer periphery of power reception coil 15A. Curved portion 57A is connected to the other end of interconnection 56A, and extends along the outer periphery of power reception coil 15A.

In coil unit 4A, “portion P1A” is a portion of power reception coil 15A that is located on the metal plate 28A side; and “portion P2A” is a portion of power reception coil 15A that is located opposite to portion P1A with respect to winding axis O1.

FIG. 10 is a plan view showing a configuration of terminals 60A, 61A and components around terminals 60A, 61A. Terminals 60A, 61A are formed similarly to terminals 60, 61. Terminal 60A includes a connection portion 70A and a protruding portion 71A. Terminal 61A includes a connection portion 73A and a protruding portion 74A.

Interconnection 54A includes an interconnection 58A and an interconnection 59A. Interconnection 59A extends in parallel with interconnection 56A and adjacent to interconnection 56A. Interconnection 58A inclines from an end of interconnection 59A toward terminal 60A. Specifically, interconnection 58A extends in a direction intersecting the direction in which interconnection 59A extends, and inclines from the end of interconnection 59A to get closer to terminal 60A.

Protruding portion 71A of terminal 60A connects between connection portion 70A and interconnection 58A, and extends inclining relative to interconnection 59A, similarly to interconnection 58A.

In FIG. 10, “distance L1A” is the distance between connection portion 70A and connection portion 73A; and “distance L2A” is the distance between protruding portion 71A and terminal 61A.

Distance L1A is the same as distance L1 shown in FIG. 7. On the other hand, as is clear from FIG. 10, distance L2A is shorter than distance L1A and distance L1. In particular, distance L2A decreases as protruding portion 71A goes from connection portion 70A toward the end of interconnection 58A.

Accordingly, in coil unit 4A in the comparative example, the insulation distance between terminal 60A and terminal 61A is short, which makes it difficult to ensure the insulating properties between terminal 60A and terminal 61A when a potential difference of several kV arises between terminal 60A and terminal 61A.

On the other hand, in coil unit 4 in the present embodiment, distance L2 is longer than distance L1 as shown in FIG. 7, which can ensure the insulating properties between terminal 60 and terminal 61 even when a potential difference of several kV arises between terminal 60 and terminal 61.

The following describes the variations in coefficient of coupling of coil units 4, 4A at the time when coil units 4, 4A are displaced relative to coil unit 3.

FIG. 11 is a plan view schematically showing a state in which coil unit 3 is displaced to the left relative to coil unit 4.

Power transmission coil 10 of coil unit 3 is long along the width direction W of vehicle 2 and is generally rectangular in shape.

Power transmission coil 10 is a spiral coil surrounding the vertically extending winding axis. Power transmission coil 10 includes long sides 95, 96 and edge sides 97, 98. Long side 95 is located on the front side, and long side 96 is located on the rear side. Edge side 97 is located on the right side, and edge side 98 is located on the left side.

In the state shown in FIG. 11, power transmission coil 10 is displaced to the left relative to power reception coil 15.

Thus, edge side 97 of power transmission coil 10 is close to portion P2 of power reception coil 15. Accordingly, when power is transmitted from power transmission coil 10 to power reception coil 15, many magnetic fluxes are interlinked between edge side 97 and portion P2 of power reception coil 15.

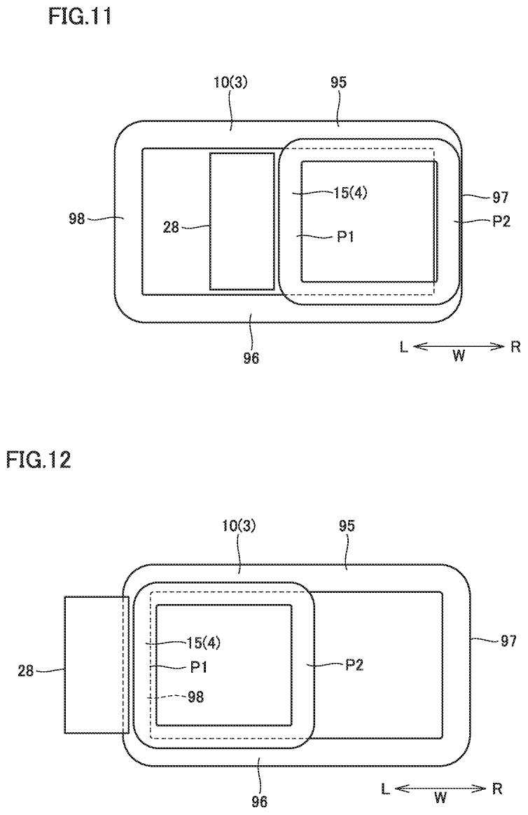

FIG. 12 is a plan view schematically showing a state in which coil unit 3 is displaced to the right relative to coil unit 4.

In the state shown in FIG. 12, portion P1 of power reception coil 15 is close to edge side 98 of power transmission coil 10. Accordingly, when power is transmitted from power transmission coil 10 to power reception coil 15, many magnetic fluxes are interlinked between portion P1 and edge side 98.

On the other hand, metal plate 28 is located adjacent to portion P1. Since metal plate 28 is composed of a metallic material, a magnetic flux incident on metal plate 28 causes an eddy current to flow on the surface of metal plate 28.

The flow of eddy current on the surface of metal plate 28 generates an electromagnetic field. This electromagnetic field is distributed in such a manner as to reduce the amount of magnetic flux incident on metal plate 28 from power transmission coil 10, thus reducing the amount of magnetic flux interlinked with portion P1 adjacent to metal plate 28.

On the other hand, the number of winding turns in portion P1 is larger than the number of winding turns in portion P2. This can prevent a large difference between the induced electromotive force generated at portion P2 with displacement as shown in FIG. 11, and the induced electromotive force generated at portion P1 with displacement as shown in FIG. 12.

Next, a case is described in which power reception coil 15A in a comparative example is displaced from power transmission coil 10.

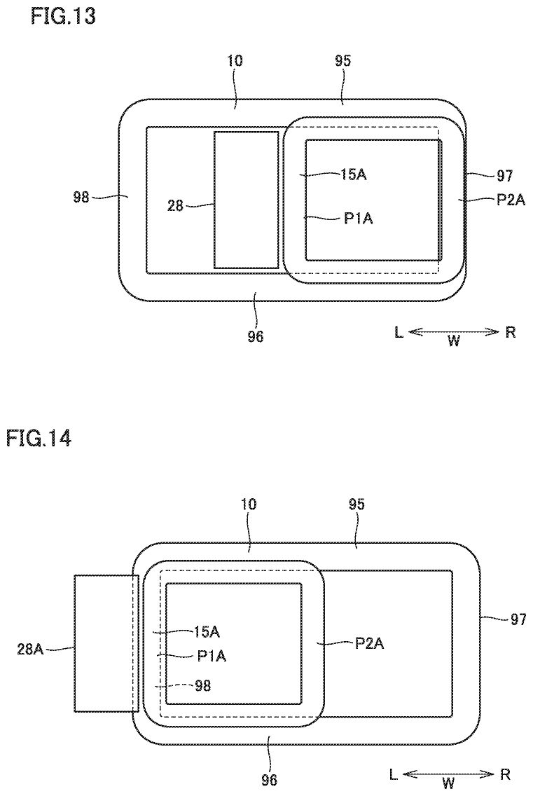

FIG. 13 is a plan view showing a state in which power transmission coil 10 is displaced to the left relative to power reception coil 15A. In the state shown in FIG. 13, edge side 97 of power transmission coil 10 is close to portion P2A of power reception coil 15A. Accordingly, when power is transmitted from power transmission coil 10 to power reception coil 15A, many magnetic fluxes are interlinked between edge side 97 of power transmission coil 10 and portion P2A of power reception coil 15A.

In FIG. 13 and FIG. 14, portion P1A of power reception coil 15A is a place corresponding to portion P1 of power reception coil 15, and portion P2A of power reception coil 15A is a place corresponding to portion P2 of power reception coil 15.

FIG. 14 is a plan view showing a state in which power transmission coil 10 is displaced to the right relative to power reception coil 15A.

In the state shown in FIG. 14, edge side 98 of power transmission coil 10 is close to portion P1A. Accordingly, when power is transmitted from power transmission coil 10 to power reception coil 15, many magnetic fluxes are interlinked between edge side 98 of power transmission coil 10 and portion P1A.

At this time, metal plate 28A is located adjacent to portion P1A. When many magnetic fluxes flow around portion P1A, a part of them is incident on metal plate 28A. A magnetic flux incident on metal plate 28A causes an eddy current to flow on the surface of metal plate 28A, and the eddy current generates an electromagnetic field. This electromagnetic field is distributed in such a manner as to reduce the amount of magnetic flux incident on metal plate 28A, thus reducing the amount of magnetic flux interlinked with portion P1A.

In power reception coil 15A in the comparative example, the number of winding turns of the coil wire is uniform over substantially the whole circumference of power reception coil 15A.

Accordingly, the amount of magnetic flux interlinked with portion P2A in the state shown in FIG. 13 is larger than the amount of magnetic flux interlinked with portion P1A in the state shown in FIG. 14. As a result, the induced electromotive force generated in power reception coil 15A is higher in the state shown in FIG. 13 than in the state shown in FIG. 14.

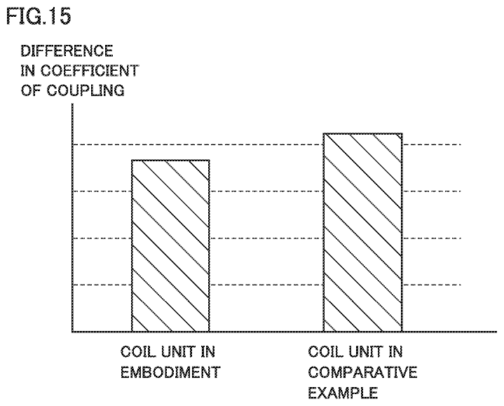

FIG. 15 is a graph showing the difference in coefficient of coupling between when power transmission coil 10 is displaced to the left relative to power reception coil 15, 15A, and when power transmission coil 10 is displaced to the right relative to power reception coil 15, 15A.

As shown in FIG. 15, the difference in coefficient of coupling of power reception coil 15 in the present embodiment is smaller than the difference in coefficient of coupling of power reception coil 15A in the comparative example.

That is, coil unit 4 in the present embodiment can reduce the variation in electrical characteristics, such as the coefficient of coupling, even when coil unit 4 is displaced to the right and left relative to coil unit 3.

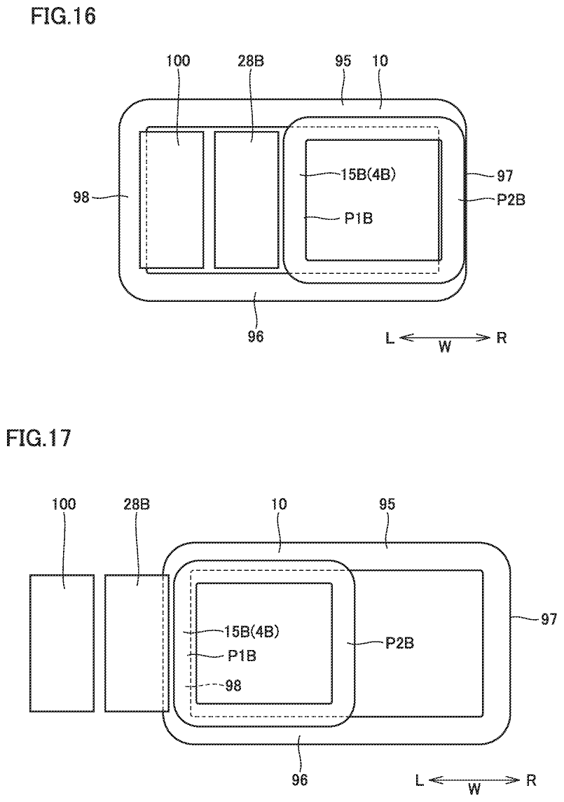

FIG. 16 is a plan view schematically showing a coil unit 4B in a variation. Coil unit 4B includes a power reception coil 15B and a metal plate 28B.

A metal component 100 is located adjacent to coil unit 4B. Metal component 100 may be, for example, an exhaust pipe on vehicle 2. Metal component 100 is located adjacent to coil unit 4B on the left of coil unit 4B. Metal component 100 is composed of a conductive metallic material.

In FIG. 16 and FIG. 17, a portion P1B of power reception coil 15B is a portion corresponding to portion P1 of power reception coil 15; and a portion P2B of power reception coil 15B is a portion corresponding to portion P2 of power reception coil 15. The number of winding turns in portion P1B is larger than the number of winding turns in portion P2B.

In the state shown in FIG. 16, power transmission coil 10 is displaced to the left relative to power reception coil 15B. Accordingly, portion P2B of power reception coil 15B is close to edge side 97 of power transmission coil 10, and many magnetic fluxes are interlinked between portion P2B and edge side 97.

FIG. 17 is a plan view showing a state in which power transmission coil 10 is displaced to the right relative to a power reception coil 15B.

In the state shown in FIG. 17, edge side 98 of power transmission coil 10 is close to portion P1B of power reception coil 15B.

Accordingly, when power is transmitted from power transmission coil 10 to power reception coil 15B, many magnetic fluxes are interlinked between edge side 98 and portion P1B.

At this time, when the amount of magnetic flux interlinked with portion P1B increases, the amount of magnetic flux incident on metal component 100 located on the portion P1B side also increases. The increased amount of magnetic flux incident on metal component 100 causes an increase in eddy current to flow on the surface of metal component 100. The increased eddy current causes an increase in intensity of the electromagnetic field generated by the eddy current. This electromagnetic field is distributed in such a manner as to reduce the amount of magnetic flux incident on metal component 100, thus reducing the amount of magnetic flux interlinked with portion P1B of power reception coil 15B.

Accordingly, the amount of magnetic flux interlinked between portion P1B of power reception coil 15B and edge side 98 of power transmission coil 10 in the state shown in FIG. 17 is smaller than the amount of magnetic flux interlinked between portion P2B of power reception coil 15B and edge side 97 of power transmission coil 10 in FIG. 16.

On the other hand, the number of winding turns in portion P1B is larger than the number of winding turns in portion P2B. Accordingly, coil unit 4B can also prevent a large variation in coefficient of coupling even when coil unit 3 is displaced to the right and left relative to coil unit 4B. Although the above embodiment describes the case for power-reception-side coil unit 4, it can also be applied to power-transmission-side coil unit 3.

Although an embodiment of the present disclosure has been described, it should be understood that the embodiment disclosed herein is by way of example in every respect, not by way of limitation. The scope of the present disclosure is defined by the terms of the claims, and is intended to include any modification within the meaning and scope equivalent to the terms of the claims.

What is claimed is:

1. A coil unit comprising:
a coil formed by winding a coil wire around a winding axis, the coil having a hole at a central part thereof; and
a device connected to the coil,
the coil wire including a conductor, and an insulation coating covering the conductor,
the coil including
a conductive first terminal formed at a first end of the coil and exposed from the insulation coating, and
a conductive second terminal formed at a second end of the coil and exposed from the insulation coating,
a portion of the coil that is located at the first end, and a portion of the coil that is located at the second end being led into the hole,
the first terminal including
a connection portion connected to an external terminal on the device, and
a protruding portion protruding from the connection portion and connected to the conductor,
the protruding portion increasing its distance from the second terminal with distance from the connection portion.

2. The coil unit according to claim 1, further comprising a metal container containing an electric device therein, wherein
the container is located adjacent to the coil, and
the number of winding turns in a first portion is larger than the number of winding turns in a second portion, the first portion being a portion of the coil that is located on a side of the container, the second portion being a portion of the coil that is located on a side opposite to the first portion with respect to the winding axis.

3. The coil unit according to claim 1, further comprising a metal member adjacent to the coil unit outside the coil unit, wherein
the number of winding turns in a third portion is larger than the number of winding turns in a fourth portion, the third portion being a portion of the coil that is located on a side of the metal member, the fourth portion being a portion of the coil that is located on a side opposite to the third portion with respect to the winding axis.
